(19) United States
(12) Patent Application Publication
(10) Pub. No.: US 2015/0187210 A1
(43) Pub. Date: Jul. 2, 2015

(54) LIGHTING CONTROL SYSTEM

(71) Applicant: Ming-Chun LI, Kaohsiung City (TW)

(72) Inventor: Ming-Chun LI, Kaohsiung City (TW)

(21) Appl. No.: 14/321,692

(22) Filed: Jul. 1, 2014

(30) Foreign Application Priority Data
Dec. 31, 2013 (TW) 102224948

(51) Int. Cl. G08C 23/04

(52) U.S. Cl. CPC G08C 23/04

(57) ABSTRACT

A lighting control system includes a control device, an infrared emitting device and a light emitting device. The infrared emitting device is controlled by the control device to output an infrared signal conveying a light modulating instruction. The light emitting device includes a user-carried component on which a light emitting element and a light modulating unit are disposed. The light modulating unit includes a receiver module for receiving the infrared signal, a decode module for decoding the infrared signal to obtain the light modulating instruction, and a light modulating module for driving the light emitting element to emit light according to the light modulating instruction.

### CROSS-REFERENCE TO RELATED APPLICATION

This application claims priority to Taiwanese Application No. 102224948, filed on Dec. 31, 2013.

### BACKGROUND OF THE INVENTION

1. Field of the Invention

This invention relates to a lighting control system, more particularly to a lighting control system using infrared remote control techniques.

2. Description of the Related Art

In recent years, electronic lighting devices carried and operated by audience participating in a concert have been developed to present various visual effects, creating an atmosphere, such as sentimental, passionate, and touching/heartwarming atmosphere, along with the music played in the concert.

However, the lighting devices are individually operated by the audience, which results in lack of organization of lighting effect and adversely affects the atmosphere desired to be presented.

### SUMMARY OF THE INVENTION

Therefore, the object of the present invention is to provide a lighting control system capable of being controlled via infrared transmission.

According to this invention, alighting control system includes a control device, an infrared emitting device and at least one light emitting device. The infrared emitting device is controlled by the control device to output an infrared signal conveying a light modulating instruction provided by the control device. The light emitting device includes a user-carried component, a light emitting element disposed at the user-carried component and configured for emitting light, and a light modulating unit disposed at the user-carried component. The light modulating unit includes a receiver module for receiving the infrared signal, a decode module for decoding the infrared signal to obtain the light modulating instruction, and a light modulating module for driving the light emitting element to emit light according to the light modulating instruction.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic perspective view of a preferred embodiment of a lighting control system according to the present invention;

FIG. 2 is a schematic front view of a light emitting device of the lighting control system; and

FIG. 3 is a block diagram illustrating detailed structure of the preferred embodiment.

### DETAILED DESCRIPTION OF THE PREFERRED EMBODIMENT

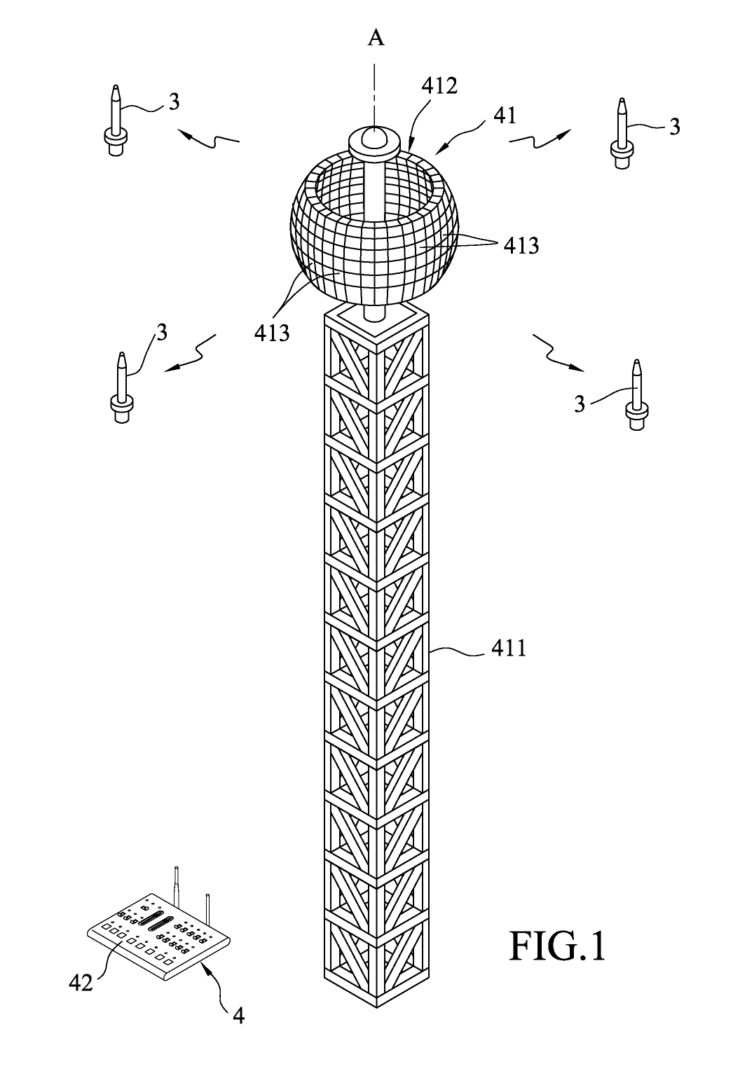

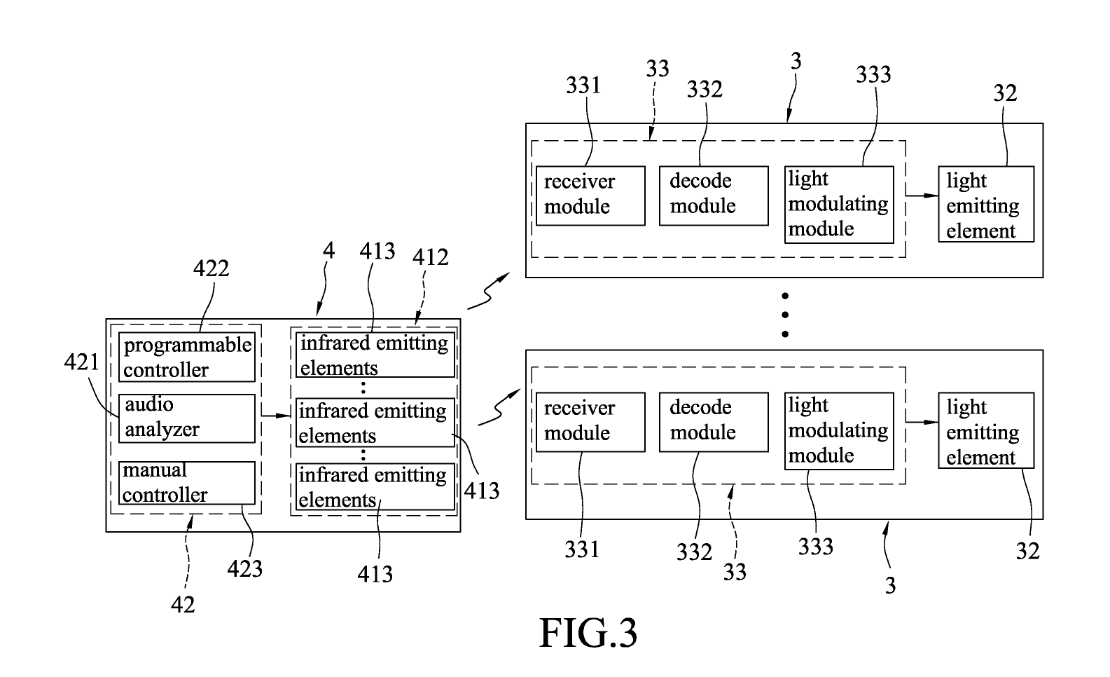

Referring to FIGS. 1 to 3, the preferred embodiment of the lighting control system is, for example, provided for use in a concert. The lighting control system includes a plurality of light emitting devices 3 to be carried by audience participating in the concert, an infrared emitting device 41, and a control device 42.

The infrared emitting device 41 is controlled by the control device 42 to output an infrared signal conveying a light modulating instruction provided by the control device 42.

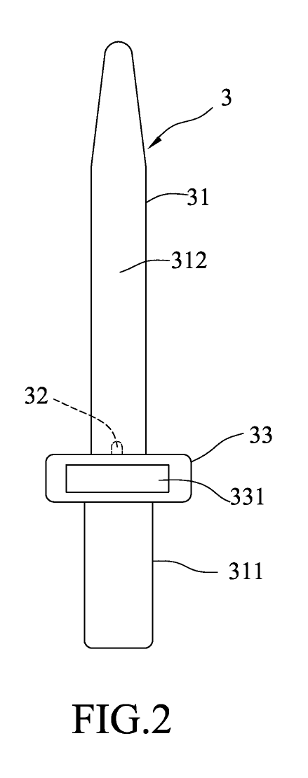

Since the structures of the light emitting devices 3 are substantially the same, only one of the light emitting devices 3 will be described herein for the sake of brevity. As shown in FIG. 2, the light emitting device 3 includes a user-carried component 31, a light emitting element 32 and a light modulating unit 33. The user-carried component 31 includes an elongated hand held casing 311 and a light transmissive casing 312. Note that the configuration of the user-carried component 31 is not limited to what is disclosed herein. For example, in other embodiments, the user-carried component 31 may be configured for wearing on the head of a user. The light transmissive casing 312 accommodates the light emitting element 32 to allow light emitted from the light emitting element 32 to propagate therethrough. In this embodiment, the light emitting element 32 is a multi-color light emitting diode (LED) , and may be a light bulb, a laser lamp or a single-color LED in other embodiments of this invention.

The light modulating unit 33 is disposed at the hand held casing 311, and includes a receiver module 331, a decode module 332 and a light modulating module 333. The receiver module 331 is disposed at the outside of the hand held casing 311, and is for receiving the infrared signal outputted by the infrared emitting device 41. The decode module 332 is for decoding the infrared signal to obtain the light modulating instruction conveyed by the infrared signal. The light modulating module 333 is for driving the light emitting element 32 to emit light according to the light modulating instruction obtained by the decode module 332. For example, the light emitting element 32 is driven to emit light having a particular color, to decrease or increase illumination of light, to emit light continuously, to blink, or to be turned off according to the light modulating instruction.

The control device 42 may be disposed in a center of the concert hall, is operated by personnel of a concert organizer or a concert venue, and is wired or wirelessly communicated with the infrared emitting device 41. In this embodiment, the control device 42 includes an audio analyzer 421, a programmable controller 422 and a manual controller 423. Note that the control device 42 may only include one or two of the audio analyzer 421, the programmable controller 422 and a manual controller 423 in other embodiments of this invention.

The audio analyzer 421 is for receiving and analyzing an audio signal (e.g., the music played in the concert) so as to generate a plurality of light modulating instructions associated respectively with various frequencies of the audio signal. For example, the light modulating instructions generated by the audio analyzer 421 may cause the light emitting element 32 to emit light having different visual effects at various frequencies of the audio signal, respectively. In this embodiment, the audio analyzer 421 is directly connected to an audio signal source, which outputs the audio signal, via an audio cable for receiving the audio signal. The audio analyzer 421 may be disposed adjacent to a speaker (not shown) that outputs the audio signal to receive the audio signal. In other embodiments of this invention, the audio analyzer 421 may receive audio signals both from an audio cable and a speaker.

In this embodiment, the programmable controller 422 is programmed, in advance, to be embedded with a sequence of light modulating instructions, and to enable the infrared emitting device 41 to output the infrared signal conveying the light modulating instructions. Note that in other embodiments, the programmable controller 422 may be connected to a front-end device (not shown) to receive the light modulating instructions therefrom. The programmable controller 422 may be configured to output a particular one of the light modulating instructions at a predetermined time point or under a predetermined condition.

The manual controller 423 is for generating a plurality of light modulating instructions manually by the concert personnel. In other embodiments, the manual controller 423 may be stored with a plurality of light modulating instructions, and is operated manually to output the light modulating instructions to drive the light emitting element 32 to emit light accordingly. It should be noted that the light modulating instructions are conveyed by the infrared signal one at a time so as to cause the light emitting element 32 to emit the light with a corresponding one of the visual effects.

In this embodiment, the infrared emitting device 41 includes a rack 411 and a plurality of circular infrared emitting modules 412. The rack 411 is for supporting the circular infrared emitting modules 412 thereon. In this embodiment, the infrared emitting device 41 is shaped in an oblate spheroid. The infrared emitting modules 412 are arranged and stacked along an axis (A), and each includes a plurality of infrared emitting elements 413. The infrared emitting elements 413 surround the axis (A), and each emits the infrared signal in a radial outward direction that is vertical to an outer surface of the spheroid infrared emitting device 41.

Note that the infrared signals emitted by the infrared emitting elements 413 of one of the circular infrared emitting modules 412 are different, in vertical angle, from those emitted by the infrared emitting elements 413 of another one of the circular infrared emitting modules 412. Further, the receiver module 331 of the light modulating unit 33 receives the infrared signal emitted by one of the infrared emitting elements 413 that corresponds to the receiver module 331 in position.

In practice, the lighting control system may include a plurality of the infrared emitting devices 41 that are disposed at various locations of a site where the concert is being held and that are synchronized with one another. Accordingly, the light emitting devices 3 carried by the audience throughout the concert site may receive the infrared signals simultaneously, and may emit the light with the same visual effect.

To sum up, by virtue of the control device 42 and the infrared emitting device 41, the light emitting devices 3 carried by the audience emit light according to the light modulating instructions that are associated with various frequencies of the audio signal, that are varied over time, or that are generated manually, thereby presenting a desired and consistent atmosphere during a concert.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A lighting control system comprising:
a control device;
an infrared emitting device controlled by said control device to output an infrared signal conveying a light modulating instruction provided by said control device; and
at least one light emitting device including
a user-carried component,
a light emitting element disposed at said user-carried component and configured for emitting light, and
a light modulating unit disposed at said user-carried component and including a receiver module for receiving the infrared signal, a decode module for decoding the infrared signal to obtain the light modulating instruction, and a light modulating module for driving said light emitting element to emit light according to the light modulating instruction.

2. The lighting control system as claimed in claim 1, wherein said user-carried component of said light emitting device includes a light transmissive casing that accommodates said light emitting element to allow light emitted from said light emitting element to propagate therethrough.

3. The lighting control system as claimed in claim 1, wherein said control device includes at least one of a programmable controller for providing a sequence of the light modulating instructions, an audio analyzer for receiving and analyzing an audio signal so as to generate a plurality of the light modulating instructions associated respectively with various frequencies of the audio signal, and a manual controller for generating a plurality of the light modulating instructions manually, the light modulating instructions being conveyed by the infrared signal one at a time.

4. The lighting control system as claimed in claim 1, wherein said infrared emitting device includes a plurality of circular infrared emitting modules being arranged and stacked along an axis, and each of said infrared emitting modules includes a plurality of infrared emitting elements which surround the axis and each of which emits the infrared signal in a radial outward direction.

5. The lighting control system as claimed in claim 4, wherein said infrared emitting device is shaped in an oblate spheroid.

6. The lighting control system as claimed in claim 5, wherein the infrared signals emitted by said infrared emitting elements of one of said circular infrared emitting modules are different, in vertical angle, from those emitted by said infrared emitting elements of another one of said circular infrared emitting modules.

7. The lighting control system as claimed in claim 4, wherein said infrared emitting device further includes a rack for supporting said circular infrared emitting modules thereon.

8. The lighting control system as claimed in claim 7, wherein said control device includes at least one of a programmable controller for providing a sequence of the light modulating instructions, an audio analyzer for receiving and analyzing an audio signal so as to generate a plurality of the light modulating instructions associated respectively with various frequencies of the audio signal, and a manual controller for generating a plurality of the light modulating instructions manually, the light modulating instructions being conveyed by the infrared signal one at a time.

9. The lighting control system as claimed in claim 1, wherein said light emitting element of said light emitting device is one of a light bulb, a laser lamp and a light emitting diode (LED).
